(19) United States
(12) Patent Application Publication
(10) Pub. No.: US 2010/0054127 A1
(43) Pub. Date: Mar. 4, 2010

(54) AGGREGATE CONGESTION DETECTION AND MANAGEMENT

(75) Inventors: Bruce Kwan, Sunnyvale, CA (US); Puneet Agarwal, Cupertino, CA (US)

Correspondence Address: BRAKE HUGHES BELLERMANN LLP;c/o CPA Global, P.O. Box 52050, Minneapolis, MN, 55402, US

(73) Assignee: Broadcom Corporation, Irvine, CA (US)

(21) Appl. No.: 12/198,668

(22) Filed: Aug. 26, 2008

(51) Int. Cl. H04L 12/56

(52) U.S. Cl. 370/235

(57) ABSTRACT

Example embodiments of methods and apparatus for aggregate congestion detection and management are disclosed. An example method includes, receiving a data packet, where the data packet being associated with a respective destination data queue. The example method also includes determining an average queue utilization for the destination queue and determining a first aggregate utilization for a first set of data queues, the first set of data queues including the destination queue. The example method further includes determining, based on the average queue utilization and the first aggregate utilization, one or more probabilities associated with the data packet. The example method still further includes, in accordance with the one or more probabilities, randomly marking the packet to indicate a congestion state or randomly determining whether to drop the data packet. The example method also includes, dropping the packet if a determination to drop the packet is made.

### TECHNICAL FIELD

This description relates to data and network communications.

### BACKGROUND

Data communication applications and the use of data networks continue to grow at a rapid pace. Often networks used for data communication are shared, where different users and/or subscribers communicate data traffic over a common or shared network. In such situations, data traffic management is typically used to implement predictable bandwidth allocation across the various traffic flows (e.g., among users). During periods of heavy data traffic, congestion may occur in such data networks. For instance, one of more devices in a data network being oversubscribed may cause such data congestion. Oversubscription refers to the situation where the amount of traffic entering a network device exceeds the amount of data traffic exiting the network device. Data buffering resources are often used in network devices to accommodate periods of such oversubscription. However, if oversubscription persists, the data buffering resources may become fully utilized, which may then result in data loss, e.g., packet drop.

For instance, transport control protocol (TCP) networks may experience tail drop as a result of data congestion. Tail drop is where a series of data packets arriving at a network device are dropped in succession due data buffering resources in the network devices being fully utilized. In such a situation, data packets arriving at the network device having fully utilized data buffering resources are dropped due to the lack of available data buffering capacity. For TCP based networks, the network may respond by reducing the data rates of all data flows entering a congested network device by fifty percent. Such an approach may dramatically affect the bandwidth of an associated network, which may result in available data bandwidth being wasted.

In order to reduce such data loss and wasted data bandwidth, congestion detection may be used in such networks to indicate when congestion may be occurring. In response to indications that congestion may be occurring, measures can be taken to reduce the congestion in order to prevent data loss, e.g., tail drop and inefficient use of data bandwidth. One such approach is to monitor the utilization of individual data queues in a network device. When utilization of a given queue reaches a threshold amount, packets attempting to enter that queue may be selectively dropped in an attempt to reduce the congestion. For instance, packets for lower priority data traffic (e.g., best effort traffic) may be dropped.

Such approaches are, however, insufficient for network devices with data queues that have limited data buffering resources and/or shared data buffering resources. For example, for network devices that have relatively small data queues, congestion measurements on the individual queues may not provide an accurate measure of congestion. Due the size of such queues, transient increases in data traffic may cause a queue to falsely indicate the possibility of congestion because such transient increases may cause congestion indication thresholds of the queues to be momentarily exceeded. In this situation, the network device may unnecessarily drop packets as a result of such false indications of congestion.

### SUMMARY

A system and/or method for data communication, substantially as shown in and/or described in connection with at least one of the figures, as set forth more completely in the claims.

### BRIEF DESCRIPTION OF THE DRAWINGS

FIG. 1 is a block diagram illustrating a data network in accordance with an example embodiment.

FIG. 2 is a block diagram illustrating an egress port that may be implemented in the data network of FIG. 1 in accordance with an example embodiment.

FIG. 3 is flow chart illustrating a method for congestion detection and management in accordance with an example embodiment.

FIG. 4 is graph illustrating an approach for determining probabilities for marking or dropping a data packet in accordance with an example embodiment.

### DETAILED DESCRIPTION

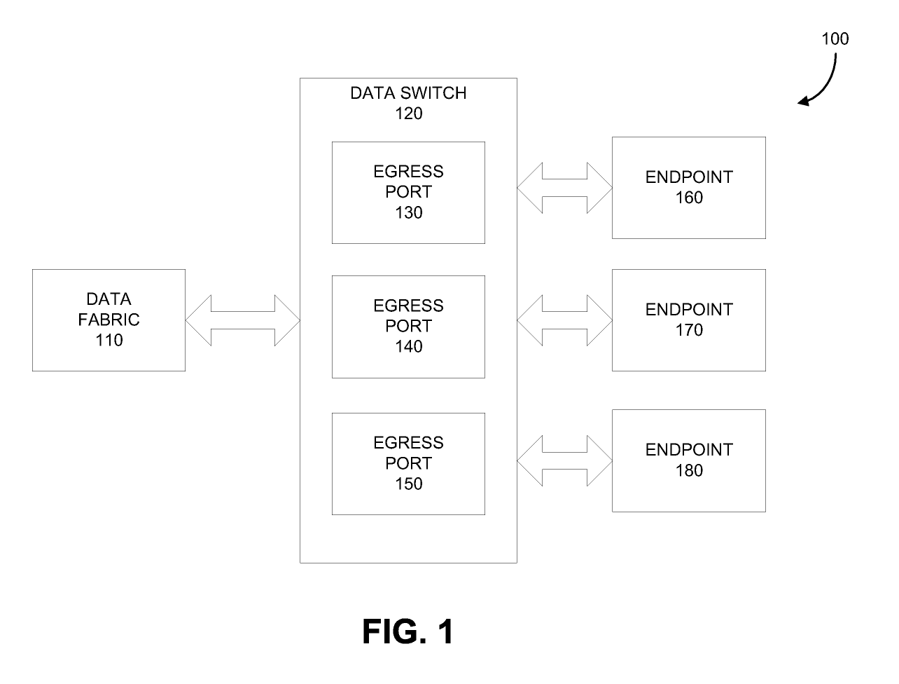

FIG. 1 is a block diagram illustrating a data network 100 in accordance with an example embodiment. In an example embodiment, the network 100 may be used to implement the aggregate congestion detection and management techniques described herein.

The network 100 may include a data fabric 110. In an example embodiment, the network 100 may be used to communicate data (e.g., packet data) from one point to another using the data fabric 110. For instance, the network 110 may receive packet data from a first network device and route (switch) that packet data to a second network device using the data fabric 110. In order to accomplish this routing, the network 100 may include any number of data switches 120 that are operationally coupled with the data fabric 110. For instance, a first data switch 120 may receive packet data from a sending device. The first data switch 120 may then route the packet data over the data fabric 110 to a second data switch 120. The second data switch 120 may then communicate the packet data to a receiving device via one or more egress ports 130, 140 and 150.

While FIG. 1 illustrates only a single data switch 120, it will be appreciated that the network 100 may include any number of data switches 120 coupled with the data fabric 110. For instance, in an example embodiment, the data fabric 110 may comprise a plurality of interconnected data switches 120 that are used for routing (switching) packet data between different points in the network 100. Similarly, while the switch 120 is illustrated with only three egress ports 130, 140 and 150, it will be appreciated that the data switch 120 may include any number of egress ports. For instance, in one example embodiment, the data switch 120 may include fewer egress ports, while in another example embodiment, the data switch 120 may include more egress ports.

Data that is communicated to the data switch 120 from the data fabric 100 may then be routed to any number of endpoints 160, 170 and 180 that are operationally coupled with the data switch 120. While, the network 100 is illustrated with only three endpoints 160, 170 and 180, it will be appreciated that the network 100 may include any number of endpoints that are operationally coupled with the data switch 120, or with other data switches 120 included in the network 100. In an example embodiment, hundreds or thousands of endpoints may be operationally coupled with the data switch 120.

In the example embodiment illustrated in FIG. 1, each of the egress ports 130, 140 and 150 may include data buffering resources for buffering data that is being communicated to the endpoints 160, 170 and 180 via the data fabric 110 and the data switch 120. In an example embodiment, the data buffering resources of the egress ports 130, 140 and 150 may be shared resources. A shared data buffering resource (e.g., a data queue) may be used, for instance, to buffer data for multiple data flows, rather than using a single data queue for buffering each individual data flow. For example, such shared data buffering resources may buffer data traffic based on class of service (COS). For instance, in an example embodiment, high priority data traffic for multiple high priority data flows may be buffered in a common data queue, while low priority data traffic (e.g., best effort traffic) for multiple low priority data flows may be buffered in another common data queue. In such an approach, data buffering resources may be shared by multiple data flows of the same traffic priority. In other embodiments, data buffering resources may be shared in any number of other fashions, such as based on the destinations of the packet data, for example.

During periods of heavy data traffic, one or more of these shared resources may become congested. Likewise, during such high traffic periods, one or more of the egress ports 120, 140 and 150 may become congested. Still further, the data switch 120, as a whole, may become congested. Using the techniques described herein, data traffic in each of the shared data buffering resources, aggregate traffic in each of the egress ports 130, 140 and 150 and the aggregate traffic in the data switch 120 may be monitored to detect data congestion.

In an example embodiment, using the approaches discussed herein, the data switch 120 may selectively and intelligently drop data packets in response to such aggregate congestion detection in order to prevent packet loss due to, for example, tail drop in transport control protocol (TCP) networks. Furthermore, by monitoring aggregate congestion for egress ports 120, 140 and 150 and the data switch 120, false indications of congestion in the shared data buffering resources may be reduced as compared to only separately monitoring congestion for each individual data buffering resource.

While the aggregate congestion detection and management techniques discussed herein are described generally with respect to the data switch 120 and the egress ports 130, 140 and 150, it will be appreciated that these techniques may be applied in any number of other arrangements. For instance, these techniques may be applied in other network devices that have data buffering resources, such as network interface cards for example. In another example embodiment, the aggregate congestion detection and management techniques described herein may be applied for data buffering resources (e.g. shared buffering resources) included in a plurality of ingress ports in a data switch 120. Such ingress ports are not shown in FIG. 1 for purpose of clarity in describing an example embodiment of aggregate congestion detection and management techniques.

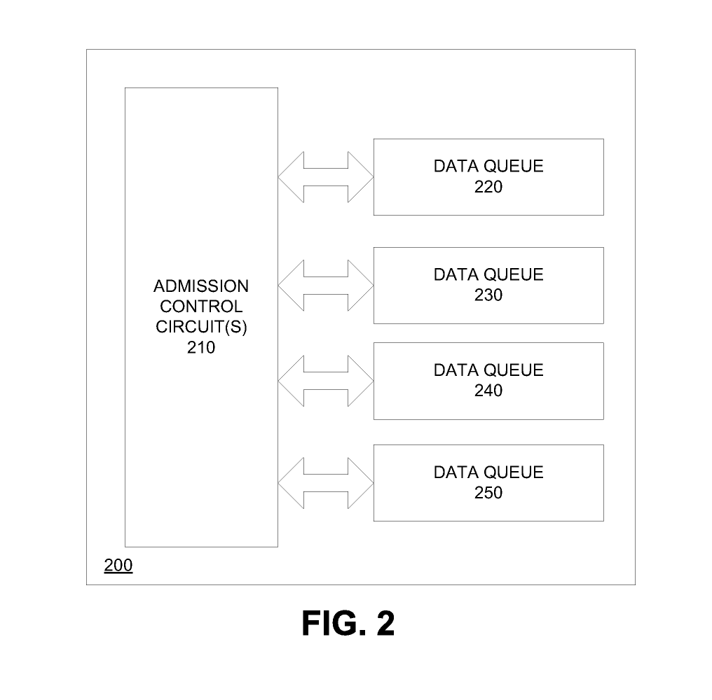

FIG. 2 is a block diagram illustrating an egress port 200 in accordance with an example embodiment. The egress port 200 may be implemented, for example, in the data switch 120 (e.g., as any one of the egress ports 130, 140 and 150) illustrated in FIG. 1. The egress port 200 shown in FIG. 2 is merely an example embodiment and any number of other possible implementations of an egress port 200 are possible.

The egress port 200 may include an admission control circuit 210. The egress port 200 may also include a set of data queues 220, 230, 240 and 250, which act as shared data buffering resources. While the admission control circuit 210 is shown as a single unit in FIG. 2, it will be appreciated that the admission control circuit 210 may include multiple admission control circuits 210, where each admission control circuit 210 is associated with a respective one of the data queues 220, 230, 240 and 250. In other example embodiments, a single, centralized admission control circuit 210 may be used to control admission of packets to the data queues 220, 230, 240 and 250.

The admission control circuit 210, in conjunction with the data queues 220, 230, 240 and 250 may determine whether there any indications of congestion in the data queues 220, 230, 240 and 250, or if there as an indication of aggregate congestion for the egress port 200. Still further, the admission control circuit 210 may communicate with other egress ports in a data switch to determine if there is an indication of aggregate congestion for the data switch.

Furthermore, while the example egress port 200 in FIG. 2 is illustrated with four data queues 220, 230, 240 and 250, it will be appreciated that the egress port 200 may include any number of data queues. For instance, in an example embodiment, the egress port 200 may include eight shared COS queues that are each used for buffering data flows having a common COS. As was discussed above, any number of other approaches for implementing data queues in the egress port 200 are possible.

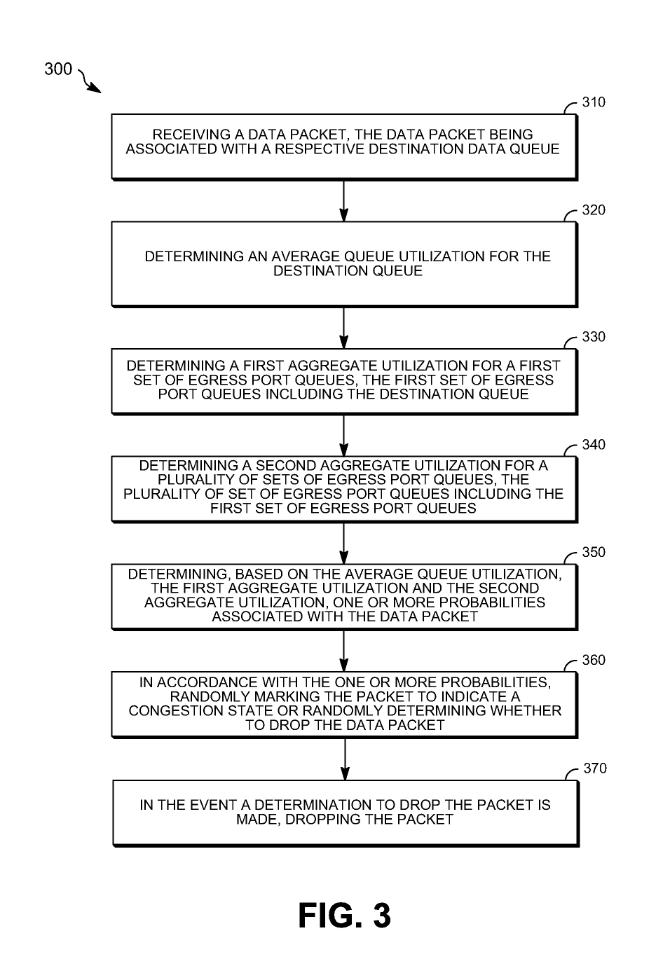

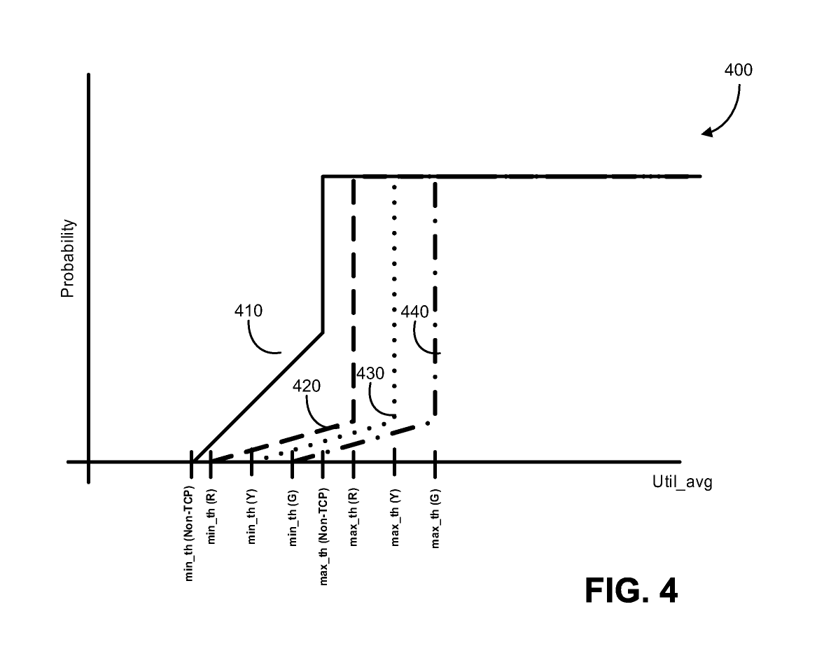

Based on the determination of an indication of data congestion in the data queues 220, 230, 240 and 250, the determination of an indication of aggregate congestion in the egress port 200 and the determination of an aggregate indication of aggregate congestion in an associated data switch, the admission control circuit 210 may take any number of actions to manage any indications that congestion is occurring or may be about to occur. Example embodiments of such actions are described in further detail below with respect to FIGS. 3 and 4.

FIG. 3 is a flowchart illustrating a method 300 for aggregate congestion detection and management in accordance with an example embodiment. The method 300 may be implemented in the network 100 illustrated in FIG. 1, where the data switch 120 of the network 100 implements the egress port 200 illustrated in FIG. 2 for its egress ports 130, 140 and 150. Accordingly, for purposes of illustration, the method 300 of FIG. 3 will be discussed with further reference to FIGS. 1 and 2. Alternatively, the method 300 may be implemented in any number of other network and/or network device configurations that include data buffering resources (e.g., limited and/or shared data buffering resources).

The method 300 includes, at block 310, receiving a data packet, where the data packet is associated with a respective destination data queue. For instance, the data packet may be associated with one of the data queues 220, 230, 240 or 250 of the egress port 200 illustrated in FIG. 2. The destination of the data packet may be specified, for example, in a header of the packet. In an example embodiment, the data packet may include a header portion, a data payload portion and one or more packet descriptors. The packet descriptors make provide information about the data packet. This information may be used by network devices in routing and communicating the packet in a data network, such as the network 100 illustrated in FIG. 1.

The method 300 may include, at block 320, determining an average queue utilization for the destination queue (e.g., for the queue of the data queues 220, 230, 240 and 250 that is associated with the data packet). At block 330, the method 300 may include determining a first aggregate utilization for a first set of egress port queues (e.g., for the egress port 200). In the method 300, the first set of egress port queues may include the destination queue. At block 340, the method 300 includes determining a second aggregate utilization for a plurality of sets of egress port queues (e.g., the egress ports 130, 140 and 150 of FIG. 1). In the method 300, the plurality of sets of egress port queues may include the first set of egress port queues.

A number of approaches may be used to determine the average queue utilization, the first aggregate utilization and the second aggregate utilization. In one example embodiment of the method 300, the average queue utilization, the first aggregate utilization and the second aggregate utilization may be calculated as respective exponentially weighted moving averages (EWMAs). An EWMA is a moving average calculation that is based on instantaneous measurements of data buffering resource utilization (e.g., for the queue, egress port and data switch) over time.

In an example embodiment, the frequency for updating the EWMA corresponding with the destination queue utilization may be determined based on a timer. Alternatively, the destination queue utilization calculation may be updated each time a data frame is sent to the destination queue. The frequency of updating the EWMAs for the first aggregate utilization (e.g., for the egress port 200) and the second aggregate utilization (e.g., for the data switch 120) may be determined in like fashion as the EWMA for the destination queue, as was described above.

In an example embodiment, the average queue utilization, the first aggregate utilization and the second aggregate utilization may each be calculated based on the following equation (Eq. 1):

Util_avg(t)=(1−W)×Util_avg(t−1)+Util_inst×W Eq. 1

where Util_avg(t) is the updated average ulitization. W is a weighting fact that may be user specified. The value of W may be adjusted to reduce or prevent the occurrence of false indications of congestion based on transient increases in data traffic that result in momentary increases in data buffering resource utilization. Util_avg(t−1) is the previous value of the utilization average being calculated. Util_inst is the instantaneous utilization of the buffering resource for which the average utilization is being calculated. The EWMAs for the average queue utilization, the first aggregate utilization and the second aggregate utilization may also be calculated using the following equation (Eq. 2), where the parameters are the same as in Eq. 1.

Util_avg(t)=Util_avg(t−1)+W×(Util_inst−Util_avg(t−1)) Eq. 2

In an example embodiment, the equations for calculating the EWMAs for the average queue utilization, the first aggregate utilization and the second aggregate utilization may be modified to better account for draining of (data exiting) the data buffering resources for which the calculations are being made. The modification to the average utilization calculations of Equations 1 and 2 is shown by the following equation (Eq. 3), where the parameters are the same as in Equations 1 and 2.

Util_avg=(Util_avg>Util_inst)?(Util_inst, Util_avg) Eq. 3

After determining the average queue utilization (block 320), the first aggregate utilization (block 330) and the second aggregate utilization (block 340), the method 300 includes, at block 350 determining one or more probabilities associated with the data packet. In the method 300, the one or more probabilities may be based on the average queue utilization, the first aggregate utilization and/or the second aggregate utilization. For instance, determining the one or more probabilities at block 350 may include determining a first probability based on the average queue utilization, determining a second probability based on the first aggregate utilization and determining a third probability based on the second aggregate utilization. An example approach for determining the one or more probabilities is illustrated in FIG. 4 and discussed in further detail below. Generally, however, as utilization of a data buffering resource (e.g., queue, egress port or data switch) increases, the associated probability determined at block 350 also increases.

In the method 300, at block 360, the one or more probabilities may be used to determine whether to mark the packet to indicate congestion or, alternatively, drop the packet. The determination to mark or drop the packet may be based on a pseudo-random function and the one or more probabilities. For instance, a random number generate may be used to generate a pseudo-random value in a specific range. The generated value may then be used as an index for a lookup table that corresponds with the one or more probabilities. The look up table will then indicate whether to mark the packet or whether to drop the packet, depending on the particular embodiment.

At block 370, the method 300 includes dropping the packet if a determination to drop the packet was made at block 360. In an example embodiment, the admission control circuit 210 of the egress port 200 of FIG. 2 may drop the packet. In such an approach, the packet is denied entrance to its destination queue. In other example embodiments, the packet may be marked with a color indicating a congestion state. For example, if no congestion is detected, the packet may be marked as green. If congestion is detected, the packet may be marked as red. In yet another example embodiment, a third color may be used as an early indication of possible data congestion. In such an approach, if an early indication of congestion is detected, the data packet may be marked yellow. Such color marking may be implemented using different bit sequences in a header of the packet or, alternatively, in a packet descriptor, as two possible examples. In an example embodiment, other network devices in a data network may use the color marking to determine whether to process or drop the packet.

In example embodiments, various approaches may be used to determine whether to mark or drop the packet based on the one or more probabilities determined at block 350 of the method 300. For instance, an aggregate probability may be determined based on two more probabilities determined at block 350. In such approach, an aggregate probability may be determined based on two or more of the following: a first probability based on the average queue utilization, a second probability based on the first aggregate utilization and a third probability based on the second aggregate utilization. For example, an aggregate probability may be determined based on any combination of the first, second and third probabilities. The exact approach may depend, at least in part, on the particular embodiment. In one example embodiment, an aggregate probability may be determined based on the first and second probability in accordance with the following equations (Eq. 4).

P(agg)=[1−(1−P1)×(1−P2)] Eq. 4

where P(agg) is the aggregate probability, P1 is the first probability (based on queue utilization) and the P2 is the second probability (based on egress port utilization). Other combinations of the first, second and third probabilities may also be used to determine (e.g., based on a pseudo-random function) whether to mark the packet to indicate congestion or drop the packet.

In other example embodiments, randomly marking the data packet to indicate a congestion state or randomly determining whether to drop the data packet may be based on only one of the following: the first probability, the second probability and the third probability. For instance, if the second aggregate utilization (for the data switch 120) indicates the presence of congestion in the data switch 120 (e.g., the second aggregate utilization is above a congestion threshold), determining whether to mark the packet may be based only on the third probability (e.g., the probability based on data switch 120 buffering resource utilization).

In another example, if the second aggregate utilization indicates that congestion is not present in the data switch 120 (e.g., is below a congestion threshold) and the first aggregate utilization indicates that congestion is present in the egress port 200 (e.g., is above a congestion threshold for the egress port 200), determining whether to mark the packet may be based only on the second probability (based on egress port 200 buffering resource utilization). In still another embodiment, if the first and second aggregate utilizations indicate that congestion is not present in the egress port 200 or the data switch 120 and the queue utilization indicates that congestion is present in the destination queue, determining whether to mark the packet may be based only on the first probability (e.g., the probability based on the destination queue buffering resource utilization).

FIG. 4 is graph 400 that illustrates an example embodiment for determining the one or more probabilities at block 350 of the method 300. The approach for determining each probability may be accomplished in similar fashion, where the values on the x-axis correspond with an amount of resource utilization (e.g., for a data queue, egress port or data switch). Those values on the x-axis may vary as appropriate for a particular embodiment. Accordingly, for the sake of brevity, the approach for determining a first probability based on a single utilization (e.g., a destination queue utilization) will be described. Other probabilities (e.g., a second probability based on egress port 200 buffer utilization and a third probability based on data switch 120 buffer utilization) may be determined in similar fashion.

In the graph 400, as discussed above, the x-axis corresponds with an amount of data buffer resource utilization. For instance, the x-axis may correspond with utilization of a destination queue, utilization of data buffering resources in an egress port (e.g., a set of COS queues) or utilization of data buffering resources in a data switch (e.g., a set of egress ports). In the graph 400, the y-axis corresponds with a probability that may be assigned based on a given utilization amount for a particular resource. Also in the graph 400, different curves may be used to assign probabilities based on different criteria. For example, for assigning probabilities in a TCP based network, the curve 410 may be used to assign probabilities to non-TCP data packets. As may be seen in the graph 400, the curve 410 will assign probabilities that will result in more aggressive marking or dropping of non-TCP packets. Such an approach may be desirable because certain types of data packets, such as user datagram protocol (UDP) packets typically do not respond well to conventional TCP drop requests. Therefore, aggressively dropping such packets in an admission control circuit when congestion occurs may help reduce overall congestion in a data network.

To assign a probability to a packet for a particular data buffering resource, the resource utilization may be compared to a first (lower limit) threshold value. For instance, for non-TCP packets in FIG. 4, the lower limit threshold value is designated as min_th (Non-TCP). If the utilization is below the lower limit threshold, the corresponding probability may be assigned a first value, in this case a probability of zero. In this situation, the packet may not be marked to indicate congestion or dropped, if the random determination is based on this probability. However, as was discussed above, the determined probability may be combined with other probabilities, or may be ignored in certain embodiments.

If the utilization exceeds the lower limit threshold, the utilization may then be compared to a second (upper limit) threshold. For non-TCP packets in FIG. 4, the upper limit threshold value is designated as max_th (Non-TCP). If the utilization is above the upper limit threshold, the corresponding probability may be assigned a second value. The second value may be an upper probability limit. Depending on the particular embodiment, the upper probability limit may be in the range of one to one-hundred percent. In an example embodiment, the upper probability limit may be in the range of five to twenty percent.

In this example, if the utilization is between the lower threshold limit and the upper threshold limit, the corresponding probability of the data packet may be assigned a value in accordance with a linear function of the utilization value. Such a linear function is represented by the linearly increasing portion of the curve 410 and, similarly, by the linearly increasing portions of curves 420, 430 and 440.

Also illustrated in FIG. 4 are three additional curves 420, 430 and 440. In an example embodiment, these curves may be used to determine probabilities for marking TCP packets to indicate congestion or to determine whether to drop packets. For instance the curve 420 may used to assign probabilities for determining (e.g., based on a pseudo-random function) whether to mark a data packet as red. The curve 420 has corresponding lower and upper threshold limits, such as were discussed above with respect to the curve 410. The curve 430 may be used to assign probabilities for determining whether to mark a packet yellow. As with the curves 410 and 420, the curve 430 has corresponding lower and upper threshold limits. In similar fashion, the curve 440 may be used to assign probabilities for determining whether to mark a packet green or, alternatively, to determine whether to drop a packet. As with the curves 410, 420 and 430, the curve 440 has corresponding lower and upper threshold limits.

The curves 410, 420, 430 and 440 illustrated in FIG. 4 are given by way of example. It will be appreciated that other curves may be used to determine the various probabilities discussed herein or the curves 410, 420, 430 and 440 may be used for assigning probabilities others than those discussed above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described greater than, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
receiving a data packet, the data packet being associated with a respective destination data queue;
determining an average queue utilization for the destination queue;
determining a first aggregate utilization for a first set of data queues, the first set of data queues including the destination queue;
determining, based on the average queue utilization and the first aggregate utilization, one or more probabilities associated with the data packet; and
in accordance with the one or more probabilities, randomly marking the packet to indicate a congestion state or randomly determining whether to drop the data packet,
wherein, in the event a determination to drop the packet is made, dropping the packet.

2. The method of claim 1, further comprising:
determining a second aggregate utilization for a second set of data queues, the second set of data queues including the first set of data queues, wherein determining the one or more probabilities is further based on the second aggregate utilization.

3. The method of claim 2, wherein the average queue utilization, the first aggregate utilization and the second aggregate utilization are respective exponentially weighted moving averages.

4. The method of claim 2, wherein:
the first set of data queues comprises a first set of egress data queues of an egress port; and
the second set of data queues comprises a plurality of sets of egress data queues for a plurality of egress ports, the plurality of sets of egress data queues including the first set of egress data queues.

5. The method of claim 2, wherein determining the one or more probabilities comprises:
comparing the second aggregate utilization with a first threshold, wherein:
in the event the second aggregate utilization is less than the first threshold, assigning a first value to a first probability;
in the event the second aggregate utilization is greater than the first threshold:
comparing the second aggregate utilization to a second threshold, the second threshold being greater than the first threshold, wherein:
in the event the second aggregate utilization is greater than the second threshold, assigning a second value to the first probability, the second value being greater than the first value; and
in the event the second aggregate utilization is less than the second threshold, assigning a third value to the first probability, the third value being a linear function of the second aggregate utilization.

6. The method of claim 2, wherein, in the event the second aggregate utilization is greater than a lower limit threshold value, determining the one or more probabilities is based only on the second aggregate utilization.

7. The method of claim 1, wherein determining the one or more probabilities for the data packet comprises:
comparing the average queue utilization with a first threshold, wherein:
in the event the average queue utilization is less than the first threshold, assigning a first value to a first probability;
in the event the average queue utilization is greater than the first threshold:
comparing the average queue utilization to a second threshold, the second threshold being greater than the first threshold, wherein:
in the event the average queue utilization is greater than the second threshold, assigning a second value to the first probability, the second value being greater than the first value; and
in the event the average queue utilization is less than the second threshold, assigning a third value to the first probability, the third value being a linear function of the average queue utilization.

8. The method of claim 7, wherein:
the first value is a lower limit;
the second value is an upper limit; and
the third value is between the first value and the second value.

9. The method of claim 1, wherein determining the one or more probabilities comprises:
comparing the first aggregate utilization with a first threshold, wherein:
in the event the first aggregate utilization is less than the first threshold, assigning a first value to a first probability;
in the event the first aggregate utilization is greater than the first threshold:
comparing the first aggregate utilization to a second threshold, the second threshold being greater than the first threshold, wherein:
in the event the first aggregate utilization is greater than the second threshold, assigning a second value to the first probability, the second value being greater than the first value; and
in the event the first aggregate utilization is less than the second threshold, assigning a third value to the first probability, the third value being a linear function of the first aggregate utilization.

10. The method of claim 1, wherein, in the event the first aggregate utilization is greater than a lower limit threshold value, determining the one or more probabilities is based only on the first aggregate utilization.

11. The method of claim 1, wherein determining the one or more probabilities comprises:
determining a first probability based on the average queue utilization;
determining a second probability based on the first aggregate utilization; and
determining an aggregate probability based on the first probability and the second probability,
wherein randomly marking the packet to indicate a congestion state or randomly determining whether to drop the data packet is based only on the aggregate probability.

12. The method of claim 1, wherein the data packet includes one or more packet descriptors.

13. The method of claim 1, wherein randomly marking the packet to indicate a congestion state or randomly determining whether to drop the data packet in accordance with the one or more probabilities comprises randomly marking the packet to indicate a congestion state or randomly determining whether to drop the data packet based on a pseudo-random function.

14. The method of claim 1, wherein determining the one or more probabilities is further based on a packet type of the data packet.

15. A method comprising:
receiving a data packet, the data packet being associated with a respective destination data queue;
determining an average queue utilization for the destination queue;
determining a first aggregate utilization for a first set of egress port queues, the first set of egress port queues including the destination queue;
determining a second aggregate utilization for a plurality of sets of egress port queues, the plurality of set of egress port queues including the first set of egress port queues;
determining, based on the average queue utilization, the first aggregate utilization and the second aggregate utilization, one or more probabilities associated with the data packet; and
in accordance with the one or more probabilities, randomly marking the packet to indicate a congestion state or randomly determining whether to drop the data packet,
wherein, in the event a determination to drop the packet is made, dropping the packet.

16. The method of claim 15, wherein determining the one or more probabilities comprises:
determining a first probability based on the average queue utilization;
determining a second probability based on the first aggregate utilization; and
determining a third probability based on the second aggregate utilization.

17. The method of claim 16, wherein:
determining the one or more probabilities further comprises determining an aggregate probability based on at least two of the first probability, the second probability and the third probability; and
randomly marking the data packet to indicate a congestion state or randomly determining whether to drop the data packet is based on the aggregate probability.

18. The method of claim 16, wherein randomly marking the data packet to indicate a congestion state or randomly determining whether to drop the data packet is based on only one of the first probability, the second probability and the third probability.

19. An apparatus comprising:
a plurality of sets of egress port queues, each set of egress port queues including a plurality of data queues;
a plurality of admission control circuits respectively associated with the plurality of data queues;
wherein each admission control circuit is configured to:
receive a data packet, the data packet being associated with a respective destination data queue of the plurality of data queues;
determine an average queue utilization for the destination queue;
determine a first aggregate utilization for a first set of egress port queues, the first set of egress port queues including the destination queue;
determine a second aggregate utilization for the plurality of sets of egress port queues, the plurality of sets of egress port queues including the first set of egress port queues;
determine, based on the average queue utilization, the first aggregate utilization and the second aggregate utilization, one or more probabilities associated with the data packet; and
in accordance with the one or more probabilities, randomly marking the packet to indicate a congestion state or randomly determining whether to drop the data packet,
wherein, in the event a determination to drop the packet is made, dropping the packet.
